(19) United States
(12) Patent Application Publication
(10) Pub. No.: US 2026/0171898 A1
(43) Pub. Date: Jun. 18, 2026

(54) PROTECTION CIRCUITS CONFIGURED FOR USE WITH MICROINVERTERS

(71) Applicant: Enphase Energy, Inc., Fremont, CA (US)

(72) Inventors: Graeme Thomas MARSHALL, Christchurch (NZ); Daniel John O’NEILL, Christchurch (NZ); Philip Mark HUNTER, Prebbleton (NZ); Henrique Rocha e MAMEDE, Christchurch (NZ)

(21) Appl. No.: 19/373,968

(22) Filed: Oct. 30, 2025

Related U.S. Application Data
(60) Provisional application No. 63/734,953, filed on Dec. 17, 2024.

(51) Int. Cl. H02M 1/32; H02M 7/537

(52) U.S. Cl. CPC H02M 1/32; H02M 7/537

(57) ABSTRACT

A protection circuit configured for use with a power converter is provided and comprises a metal oxide varistor-semiconductor protection thyristor (MOV-TSPD) circuit comprising a first MOV and a second MOV connected in series with one another and in parallel with a TSPD connected between a first leg of switches and a second leg of switches coupled in parallel to one another, wherein the MOV-TSPD circuit is configured to clamp the first leg of switches and the second leg of switches to a predetermined voltage during operation.

### CROSS-REFERENCE TO RELATED APPLICATIONS

The present application claims the benefit of and priority to United States Provisional Application Serial No. 63/734,953, filed on December 17, 2024, the entire contents of which is incorporated herein by reference.

### BACKGROUND

### Field of the Disclosure

Embodiments of the present disclosure relate generally to power conversion systems and, in particular, to protection circuits configured for use with microinverters.

### Description of the Related Art

Conventional power converters (microinverters) suitable for use with power conversion systems are known. The power converters, typically, use semiconductor switches in AC circuits. Surge protection is often required to ensure the semiconductor switches are maintained within their maximum voltage rating. Typically, one or more surge protection circuits are required. Simple surge protection devices such as Metal Oxide Varistors (MOV) have soft clamping characteristics, which can limit the operational voltage of the semiconductor switch to values well below the switch’s maximum voltage rating. Combinations of surge protection devices may be used to extend the operational voltage range of a switch closer to the maximum voltage rating. For example, series Metal Oxide Varistor – Thyristor Surge Protection Device (MOV-TSPD) circuits may allow 500 V operation of a 600 V (max rated) AC switch. Typically, surge protection is placed between the AC conductors (Phase-Neutral or L1-L2). Abnormal grid conditions can cause repeat operation of the MOV-TSPD protection leading to failure of the surge protection components. While the MOV-TSPD is effective at protecting the power converter from a line overvoltage, the MOV-TSPD does have limitations over what combinations of values can be used to keep the voltage to acceptable levels on the power converter switching devices.

Thus, the inventors provide herein improved protection circuits configured for use with microinverters.

### SUMMARY

In accordance with at least some embodiments, there is provided a protection circuit configured for use with a power converter. The protection circuit comprises a Metal Oxide Varistor – Thyristor Surge Protection Device (MOV-TSPD) circuit comprising a first MOV and a second MOV connected in series with one another and a T-connection with a TSPD connected between a first leg of switches and a second leg of switches. The MOV-TSPD circuit is configured to clamp the first leg of switches and the second leg of switches to a predetermined voltage during operation.

In accordance with at least some embodiments, there is provided a power conversion system comprising a power converter, a DC component coupled to a DC side of the power converter, a plurality of switches coupled to a primary winding of a transformer, and a bridge coupled to a secondary winding of the transformer and comprising a protection circuit. The protection circuit comprises a Metal Oxide Varistor - Thyristor Surge Protection Device (MOV-TSPD) circuit comprising a first MOV and a second MOV connected in series with one another and a T-connection with a TSPD connected between a first leg of switches and a second leg of switches. The MOV-TSPD circuit is configured to clamp the first leg of switches and the second leg of switches to a predetermined voltage during operation.

Various advantages, aspects, and novel features of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic diagram of a power conversion system comprising a switched mode power converter, in accordance with embodiments of the present disclosure;

FIG. 2 is a schematic diagram of a power conversion system comprising a switched mode power converter, in accordance with embodiments of the present disclosure;

FIG. 3 is a schematic diagram of a protection circuit configured for use with a power conversion system, in accordance with embodiments of the present disclosure;

FIG. 4 is a schematic diagram of a protection circuit configured for use with a power conversion system, in accordance with embodiments of the present disclosure;

FIG. 5 is a schematic diagram of a protection circuit configured for use with a power conversion system, in accordance with embodiments of the present disclosure; and

FIG. 6 is a schematic diagram of a protection circuit configured for use with a power conversion system, in accordance with embodiments of the present disclosure.

### DETAILED DESCRIPTION

Embodiments of the present disclosure are directed to improved protection circuits configured for use with microinverters. For example, a protection circuit configured for use with a power converter can comprise a metal oxide varistor- thyristor surge protection device (MOV-TSPD) circuit comprising a first MOV and a second MOV connected in series with one another and a T-connection with a TSPD connected between a first leg of switches and a second leg of switches. The MOV-TSPD circuit can be configured to clamp the first leg of switches and the second leg of switches to a predetermined voltage during operation. The protection circuits described herein operate in conjunction with shutdown mechanisms and provides an increased voltage withstand between the AC conductors while the AC switches are off. The possibility of repeat operation of the protection circuit is reduced during abnormal grid conditions.

The foregoing description of embodiments of the disclosure comprises a number of elements, devices, circuits and/or assemblies that perform various functions as described. These elements, devices, circuits, and/or assemblies are exemplary implementations of means for performing their respectively described functions. The improved protection circuits described herein are configured for use with several types of microinverters. For example, the improved protection circuits described herein can be configured for use with single-phase converters, three-phase converters, 208 V three-phase converters, line-to-line three-wire 208 V three-phase converters, line-to-neutral four-wire three-phase converters, and the like.

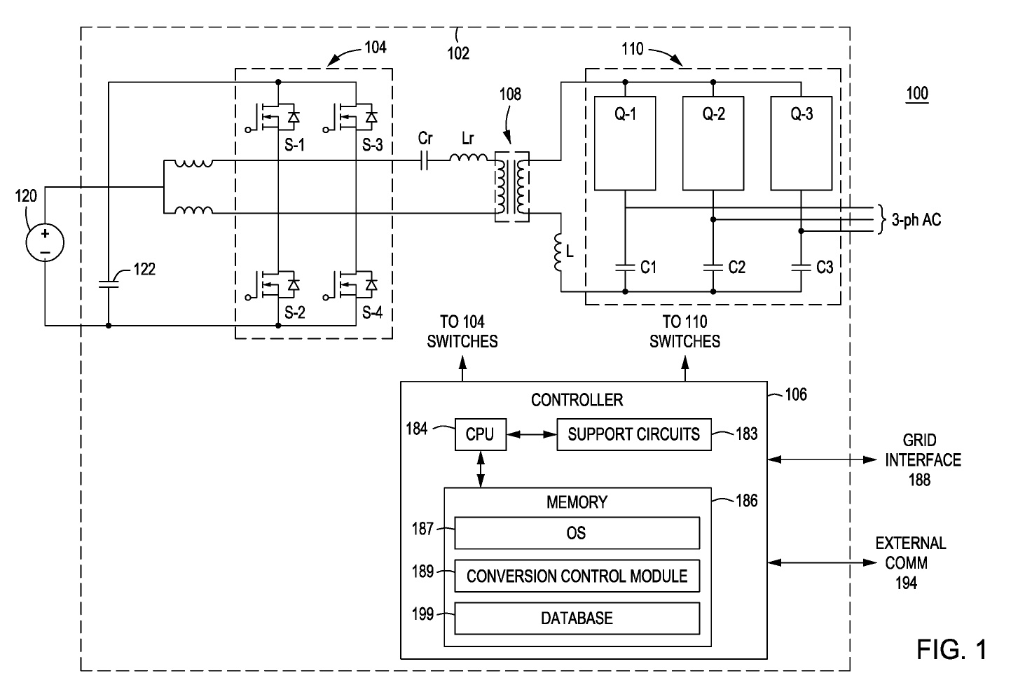

For example, FIG. 1 is a schematic diagram of a power conversion system 100 comprising a converter 102 (e.g., a switched mode power converter), in accordance with embodiments of the present disclosure. This diagram only portrays one variation of the myriad of possible system configurations. The present disclosure can function in a variety of power generation environments and systems.

The power conversion system 100 comprises a DC component 120, such as a PV module or a battery, coupled to a DC side of the converter 102 (referred to herein as “converter 102”). In other embodiments the DC component 120 may be any suitable type of DC components, such as another type of renewable energy source (e.g., wind farms, hydroelectric systems, and the like), other types of energy storage components, and the like.

The converter 102 comprises a capacitor 122 coupled across the DC component 120 as well as across an H-bridge 104 formed from switches S-1, S-2, S-3 and S-4. The switches S-1 and S-2 are coupled in series to form a left leg of the H-bridge 104, and the switches S-3 and S-4 are coupled in series to form a right leg of the H-bridge 104.

The output of the H-bridge 104 is coupled across a series combination of a capacitor Cr and inductor L, which form a resonant tank, and the primary winding of a transformer 108. In other embodiments, the resonant tank may be formed by a different configuration of the capacitor Cr and the inductor Lr (e.g., the capacitor Cr and the inductor L may be coupled in parallel); in some embodiments, Lr may represent a leakage inductance from the transformer 108 rather than a physical inductor.

A series combination of the secondary winding of the transformer 108 and an inductor L is coupled across a bridge which produces a three-phase AC output, although in other embodiments the bridge may produce one or two phases of AC at its output. The bridge can be a half-bridge, full-bridge, Hex-bridge, etc. formed using switches that are arranged to enable current flow to be alternated. For example, the switches can comprise one or more semiconductor (or vacuum tube) devices, e.g., Field Effect Transistor (FET), Junction FET (JFET), Metal Oxide Semiconductor FET (MOSFET), High Electron Mobility Transistor (HEMT), etc. The switches can be used for AC-DC conversion and/or DC-AC conversion (e.g., switches that are controllable). The bridge can be a Bi-directional bridge (sometimes referred to as a cycloconverter bridge or cycloconverter for short) that uses two Uni-Directional switches connected in series (back-to-back, which can be referred to as Bi-directional switches) –which can conduct current in either direction (when turned on), can block a voltage of either polarity (when turned off), and can also block a voltage in both polarities (e.g., block polar voltage). For illustrative purposes, the secondary winding of the transformer 108 and the inductor L are assumed coupled across a cycloconverter 110. The cycloconverter 110 comprises three 4Q bi-directional switches Q-1, Q-2, and Q-3 (which may be collectively referred to as switches Q) respectively in a first leg, a second leg, and a third leg (three-leg power converter) coupled in parallel to one another. In at least some embodiments, the cycloconverter 110 can be made into a four-leg power converter, which is three-phases plus a neutral. In accordance with embodiments of the present disclosure, each of the switches Q-1, Q-2, and Q-3 is a native four quadrant bi-directional switch comprising one or more of the aforementioned semiconductor (or vacuum tube) devices. Alternatively or additionally, the cycloconverter 110 can comprise three monolithically formed switches (e.g., a Monolithic Bi-Directional Switch (MBDS)) –Gallium-Nitride (GaN) based on a HEMT structure, as described in greater detail below. That is, the MBDS refers to the fact that this Bi-Directional Switch (BDS) can be built in a single semiconductor die. In at least some embodiments, each of the switches Q-1, Q-2, and Q-3 comprises a pair of Gallium-Nitride (GaN) High Electron Mobility Transistors. In at least some embodiments, each of the switches Q-1, Q-2, and Q-3 comprises a first pair of Gallium-Nitride (GaN) High Electron Mobility Transistors and a second pair of Gallium-Nitride (GaN) High Electron Mobility Transistors connected in series.

The first cycloconverter leg comprises the 4Q switch Q-1 coupled to a capacitor C1, the second cycloconverter leg comprises the 4Q switch Q-2 coupled to a capacitor C2, and the third cycloconverter leg comprises a 4Q switch Q-3 coupled to a capacitor C3. A first AC output phase line is coupled between the switch Q-1 and the capacitor C1, a second AC output phase line is coupled between the switch Q-2 and the capacitor C2, and a third AC output phase line is coupled between the switch Q-3 and the capacitor C3. The converter 102 may also include additional circuitry not shown, such as voltage and/or current monitors, for obtaining data for power conversion, data reporting, and the like.

The converter 102 additionally comprises a controller 106 coupled to the H-bridge switches (S-1, S-2, S-3, and S-4) and the cycloconverter switches (Q-1, Q-2, and Q-3) for operatively controlling the switches to generate the desired output power. In some embodiments, the converter 102 may function as a bi-directional converter.

The controller 106 comprises a CPU 184 coupled to each of support circuits 183 and a memory 186. The CPU 184 may comprise one or more conventionally available microprocessors or microcontrollers. Additionally or alternatively, the CPU 184 may include one or more application specific integrated circuits (ASICs). The support circuits 183 are well known circuits used to promote functionality of the CPU 184. Such circuits include, but are not limited to, a cache, power supplies, clock circuits, buses, input/output (I/O) circuits, and the like. The controller 106 may be implemented using a general purpose computer that, when executing particular software, becomes a specific purpose computer for performing various embodiments of the present disclosure.

The memory 186 is a non-transitory computer readable storage medium such as random access memory, read only memory, removable disk memory, flash memory, and various combinations of these types of memory. The memory 186 is sometimes referred to as main memory and may, in part, be used as cache memory or buffer memory. The memory 186 generally stores the OS 187 (operating system), if necessary, of the controller 106 that can be supported by the CPU capabilities . In some embodiments, the OS 187 may be one of a number of commercially available operating systems such as, but not limited to, LINUX, Real-Time Operating System (RTOS), and the like.

The memory 186 may store various forms application software (e.g., instructions), such as a conversion control module 189 for controlling power conversion by the converter 102, for example maximum power point tracking (MPPT), switching, performing the methods described herein, and the like. The memory 186 may further store a database 199 for storing various data. The controller 106 further processes inputs and outputs to external communications 194 (i.e., gateway) and a grid interface 188.

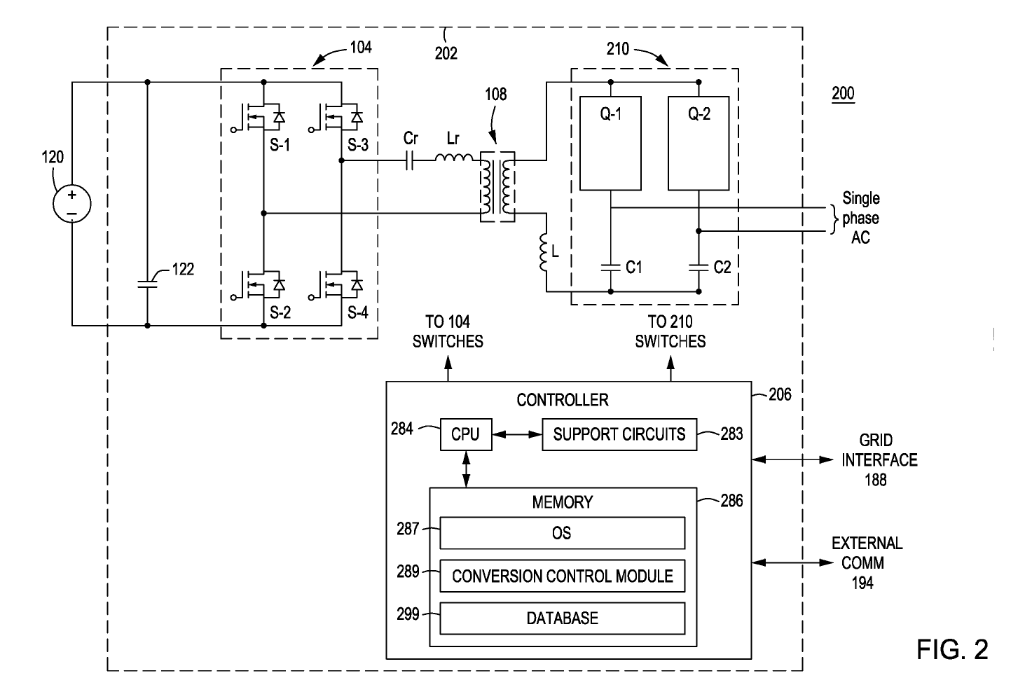

FIG. 2 is a schematic diagram of a power conversion system 200 comprising a converter 202 (e.g., a switched mode power converter), in accordance with embodiments of the present disclosure.

The power conversion system 200 comprises the DC component 120 coupled to a DC side of the converter 202. The converter 202 comprises the capacitor 122 coupled across the DC component 120 and the H-bridge 104, as described above with respect to the converter 102. The output of the H-bridge 104 is coupled across a series combination of the capacitor Cr and the inductor Lr, which form a resonant tank, and the primary winding of the transformer 108, as described above with respect to the converter 102. In other embodiments, the resonant tank may be formed by a different configuration of the capacitor Cr and the inductor Lr (e.g., the capacitor Cr and the inductor L may be coupled in parallel); in some embodiments, Lr may represent a leakage inductance of the transformer 108 rather than a physical inductor.

A series combination of the secondary winding of the transformer 108 and the inductor L can be coupled across a bridge as described above with respect to FIG. 1. For example, the secondary winding of the transformer 108 and the inductor L can be coupled across a cycloconverter 210 which produces a single-phase AC output. For example, the cycloconverter 210 comprises two bi-directional switches Q-1 and Q-2, (collectively referred to as switches Q) respectively in a first leg and a second leg (two-leg power converter) coupled in parallel to one another. In accordance with embodiments of the present disclosure, each of the switches Q-1 and Q-2 is a native four quadrant bi-directional switch comprising one or more of the aforementioned semiconductor (or vacuum tube) devices. Alternatively or additionally, the cycloconverter 210 can comprise two monolithically formed switches (e.g., a Monolithic Bi-Directional Switch (MBDS)) –Gallium-Nitride (GaN) based on a HEMT structure, as described in greater detail below. In at least some embodiments, each of the switches Q-1 and Q-2 comprises a pair of Gallium-Nitride (GaN) High Electron Mobility Transistors. In at least some embodiments, each of the switches Q-1 and Q-2 comprises a first pair of Gallium-Nitride (GaN) High Electron Mobility Transistors and a second pair of Gallium-Nitride (GaN) High Electron Mobility Transistors connected in series.

The first cycloconverter leg comprises the 4Q switch Q-1 coupled to the capacitor C1, and the second cycloconverter leg comprises the 4Q switch Q-2 coupled to the capacitor C2. A first AC output phase line is coupled between the switch Q-1 and the capacitor C1, and a second AC output phase line is coupled between the switch Q-2 and the capacitor C2. The converter 202 may also include additional circuitry not shown, such as voltage and/or current monitors, for obtaining data for power conversion, data reporting, and the like.

The converter 202 additionally comprises a controller 206 coupled to the H-bridge switches (S-1, S-2, S-3, and S-4), and the cycloconverter switches (Q-1 and Q-2) for operatively controlling the switches to generate the desired output power. In some embodiments, the converter 202 may function as a bi-directional converter.

The controller 206 comprises a CPU 284 coupled to each of support circuits 283 and a memory 286. The CPU 284 may comprise one or more conventionally available microprocessors or microcontrollers. Additionally or alternatively, the CPU 284 may include one or more application specific integrated circuits (ASICs). The support circuits 283 are well known circuits used to promote functionality of the CPU 284. Such circuits include, but are not limited to, a cache, power supplies, clock circuits, buses, input/output (I/O) circuits, and the like. The controller 206 may be implemented using a general purpose computer that, when executing particular software, becomes a specific purpose computer for performing various embodiments of the present disclosure.

The memory 286 is a non-transitory computer readable medium such as random access memory, read only memory, removable disk memory, flash memory, and various combinations of these types of memory. The memory 286 is sometimes referred to as main memory and may, in part, be used as cache memory or buffer memory. The memory 286 generally stores the OS 287 (operating system), if necessary, of the controller 206 that can be supported by the CPU capabilities. In some embodiments, the OS 287 may be one of a number of commercially available operating systems such as, but not limited to, LINUX, Real-Time Operating System (RTOS), and the like.

The memory 286 may store various forms of application software, such as a conversion control module 289 for controlling power conversion by the converter 202, for example maximum power point tracking (MPPT), switching, and the like. The memory 286 may further store a database 299 for storing various data. The controller 206 further processes inputs and outputs to external communications 194 (i.e., gateway) and the grid interface 188.

As noted above, embodiments of the present disclosure are directed to improved protection circuits configured for use with microinverters. For example, the protection circuits described herein can be configured for use with one or more converters (e.g., the converters of FIGS. 1 and 2, two-leg, three-leg, four-leg, etc.). For illustrative purposes, the protection circuits are described in terms of use with the cycloconverter 210, which produces a single-phase AC output for the converter 202 of FIG. 2 (e.g., two-leg).

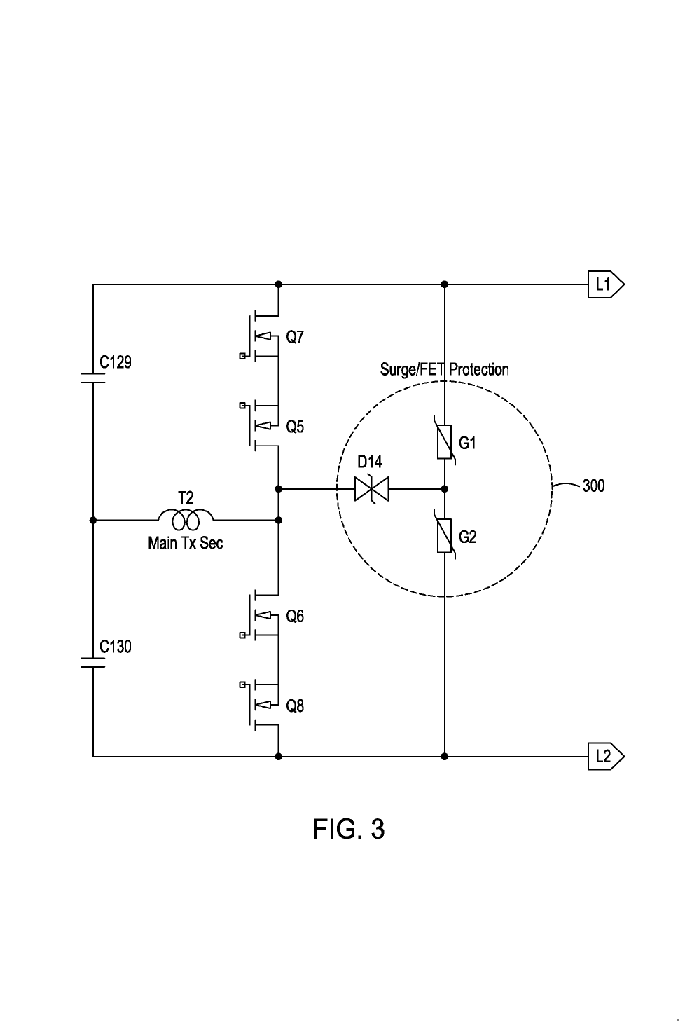

For example, FIG. 3 is a schematic diagram of a protection circuit 300 configured for use with, for example, a power conversion system of FIG. 1 and FIG. 2, in accordance with embodiments of the present disclosure. For example, the protection circuit 300 comprises a metal oxide varistor- thyristor surge protection device (MOV-TSPD) circuit that comprises a first MOV G₁and a second MOV G₂ connected in series with one another and in a T-connection with a TSPD D₁₄. The TSPD D₁₄is connected between a first leg of switches Q₇ and Q₅(e.g., Q-1, FETS, GaN FET, etc.) and a second leg of switches Q₆ and Q₈ (e.g., Q-2, FETS, GaN FET, etc.) coupled in parallel to one another. The first leg of switches Q₇ and Q₅and the second leg of switches Q₆ and Q₈form a bridge that is coupled to a secondary winding T₂ of a transformer (e.g., the transformer 108). The first leg of switches Q₇ and Q₅are coupled to a capacitor C₁₂₉ (e.g., the capacitor C1), and the second leg of switches Q₆ and Q₈ are coupled to a capacitor C₁₃₀ (the capacitor C2). The first leg of switches Q₇ and Q₅and the second leg of switches Q₆ and Q₈ can be rated to any suitable voltage. For example, the first leg of switches Q₇ and Q₅and the second leg of switches Q₆and Q₈ can be rated to the combined clamping voltage of the first MOV G₁,the second MOV G₂, and the TSPD D₁₄ so that the first MOV G₁,the second MOV G₂, and the TSPD D₁₄ maximum combined clamping voltage does not exceed a voltage rating of the individual switches Q₆, Q₈ Q₇, and Q₅. In at least some embodiments, a voltage rating of the individual switches Q₆, Q₈ Q₇, and Q₅can be about 600 V to about 800 V, e.g., 650 V. Additionally, the TSPD D₁₄can be rated to any suitable voltage. For example, the TSPD D₁₄ can be rated from about 190 V to about 220 V, e.g., 190 V. Moreover, the first MOV G₁and the second MOV G₂can be rated to any suitable voltage. For example, the first MOV G₁and the second MOV G₂can be rated from about 175 V to about 210 V, e.g., 175 V.

The MOV-TSPD circuit is configured to actively protect the first leg of switches Q₇ and Q₅ and the second leg of switches Q₆ and Q₈ when the first leg of switches Q₇ and Q₅and the second leg of switches Q₆ and Q₈s are switching. For example, the MOV-TSPD circuit is configured to clamp the first leg of switches Q₇ and Q₅and the second leg of switches Q₆ and Q₈ to a predetermined voltage during operation. As noted above, in at least some embodiments, the predetermined voltage is about 600 V. Additionally, when the first leg of switches Q₇ and Q₅and the second leg of switches Q₆ and Q₈are not switching (e.g., off), the first MOV G₁and the second MOV G₂are configured to not trigger (e.g., activate) until a voltage exceeds well above the first MOV G₁and the second MOV G₂ combined series voltage. In at least some embodiments, when the first leg of switches Q₇ and Q₅and the second leg of switches Q₆ and Q₈ are not switching, the voltage clamp across the line can be double the rated voltage of the first leg of switches Q₇ and Q₅and the second leg of switches Q₆ and Q₈since there will always be two of the switches (e.g., in series). Therefore, the combined maximum clamp voltage of the first MOV G₁and the second MOV G₂ can be twice the voltage rating of the switches.

Additionally, when the first leg of switches Q₇ and Q₅ and the second leg of switches Q₆ and Q₈ are off, the first leg of switches Q₇ and Q₅and the second leg of switches Q₆ and Q₈only need protecting from voltages over a combined rated voltage of the first leg of switches Q₇ and Q₅ (e.g., 2 x 600 V) or a combined rated voltage of the second leg of switches Q₆ and Q₈ (e.g., 2 x 800 V).

In at least some embodiments, when the controller 106 and/or the grid interface 188 detects an abnormal waveform (e.g., abnormal AC waveform appears), the MOV-TSPD circuit is further configured to shut down the converter and return the converter to normal operation when the abnormal AC waveform disappears. Additionally, because the MOV-TSPD circuit is configured to dissipate energy stored in the resonant circuit (e.g., the capacitor Cr and inductor L, which form a resonant tank), the MOV-TSPD circuit resolves avalanche issues (e.g., resonant tank inductor current at shutdown) with the first leg of switches Q₇ and Q₅and the second leg of switches Q₆ and Q₈. For example, the MOV-TSPD circuit can clamp the voltages between the second leg of switches Q₆ and Q₈(or the first leg of switches Q₇ and Q₅) when a shutdown occurs that generates voltages that could damage the switches from other circuitry connected to this node.

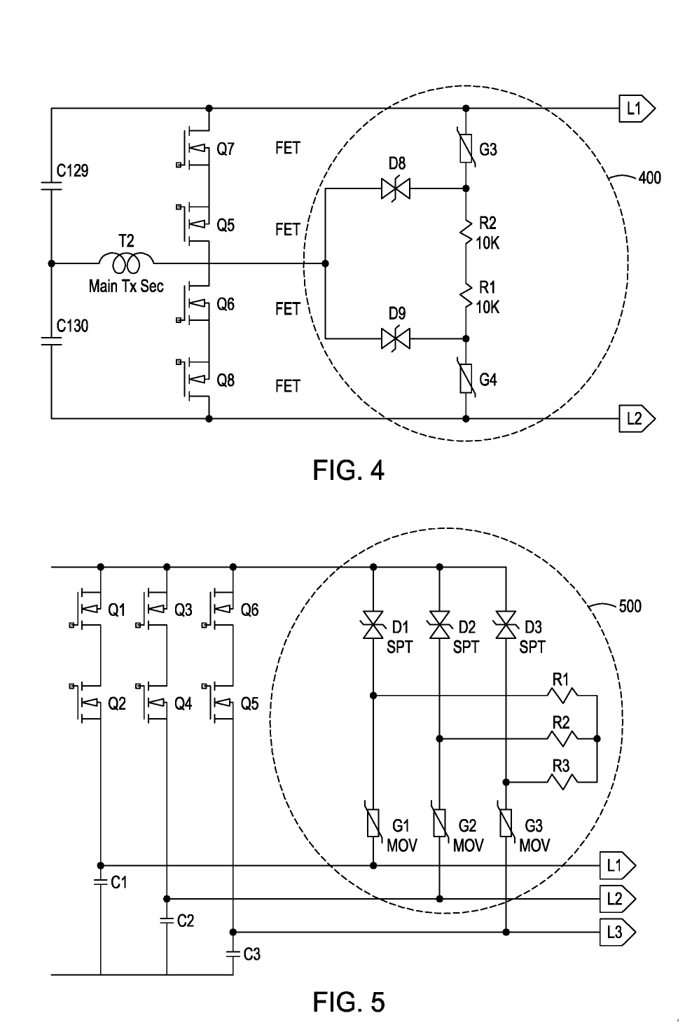

FIG. 4 is a schematic diagram of a protection circuit configured for use with, for example, the power conversion system of FIG. 1 and FIG. 2, in accordance with embodiments of the present disclosure. The protection circuit of FIG. 4 is substantially identical to the protection circuit of FIG. 3. Accordingly, only those features that are unique to FIG. 4 are disclosed herein. For example, a MOV-TSPD circuit 500 can comprise a first TSPD D₈ and a second TSPD D₉that are coupled in parallel to one another and connected between the first leg of switches Q₇ and Q₅ (e.g., Q-1, FETS, GaN FET, etc.) and the second leg of switches Q₆ and Q₈ (e.g., Q-2, FETS, GaN FET, etc.) coupled in parallel to one another. The TSPD D₈ and the second TSPD D₉ can be rated as described above. Additionally, one or more resistors can be provided between a first MOV G₃ and a second MOV G₄. In at least some embodiments, a resistor R₂ and a resistor R₁ can be connected in series with each other and between the first MOV G₃ and the second MOV G₄. The resistor R₂ and the resistor R₁ can each have a resistance of about 10 kΩ. Alternatively, one resistor can be provided and can have a resistance of about 20 kΩ. At line voltages (L1 to L2) where the power converter is expected to operate, the combined resistance of R1 + R2 should be significantly lower than the (non-linear) resistance of MOVs G3 +G4, so that minimal voltage is dropped across resistors R1 & R2, and the T connections of TSPD D8 & D9 is biased to approximately half the L1-L2 voltage.

The resistor R₂ and the resistor R₁ in combination with the first MOV G₃ and the second MOV G₄allow the MOV-TSPD circuit 500 to change a trigger point of the MOV-TSPD circuit 500. The additional TSPD (e.g., either the first TSPD D₈ or the second TSPD D₉) is required/configured to ensure the clamping voltage is equivalent for all switches no matter the polarity of the over voltage event.

FIG. 5 is a schematic diagram of a protection circuit configured for use with, for example, a line-to-line three-wire three-phase power conversion system, in accordance with embodiments of the present disclosure. The protection circuit of FIG. 5 is substantially identical to the protection circuits of FIG. 3 and FIG. 4. Accordingly, only those features that are unique to FIG. 5 are disclosed herein. For example, a MOV-TSPD circuit 500 can comprise a first TSPD D₁,a second TSPD D₂, and a third TSPD D₃that are coupled in parallel to one another and connected to a first leg of switches Q₁ and Q₂(e.g., Q-1, FETS, GaN FET, etc.), a second leg of switches Q₃ and Q₄ (e.g., Q-2, FETS, GaN FET, etc.), and a third leg of switches Q₆ and Q₅ (e.g., Q-3, FETS, GaN FET, etc.), which are coupled in parallel to one another. The first TSPD D₁,the second TSPD D₂, and the third TSPD D₃can be rated as described above. A first MOV G₁,a second MOV G₂, and a third MOV G₃ are respectively connected in series with the first TSPD D₁,the second TSPD D₂, and the third TSPD D₃, and a resistor R₁,a resistor R₂ and a resistor R₃ can be respectively connected between the first MOV G₁,the second MOV G₂, the third MOV G3 and the first TSPD D₁,the second TSPD D₂, the third TSPD D₃. The resistor R₁, the resistor R₂,and the resistor R₃can function similarly to the resistor R₁ and the resistor R₂of FIG. 4.

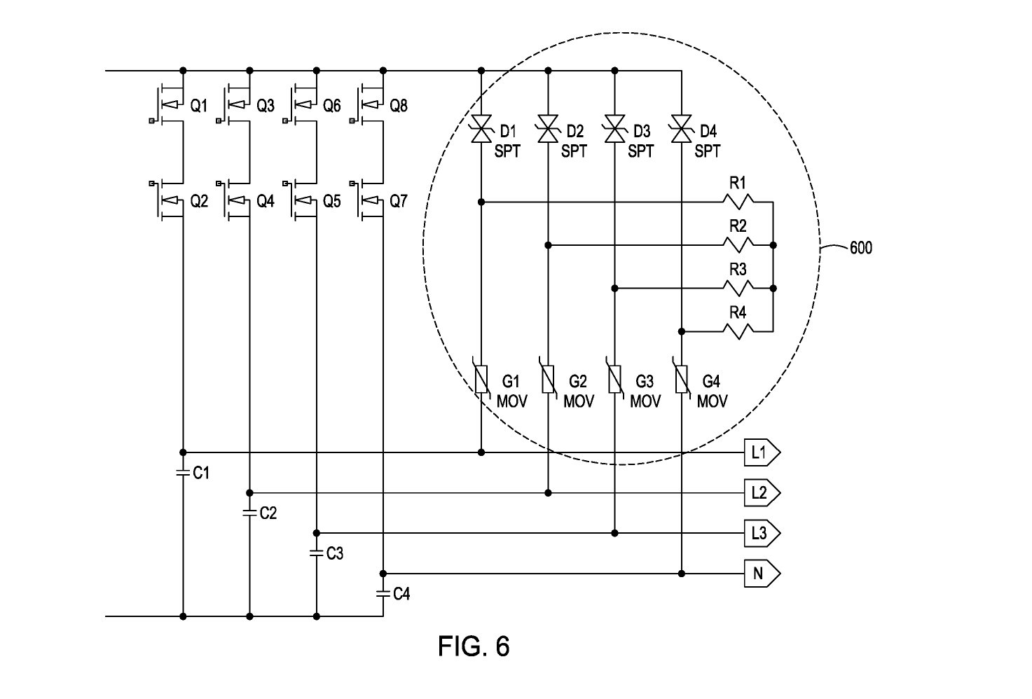

FIG. 6 is a schematic diagram of a protection circuit configured for use with, for example, a line-to-line four-wire three-phase power conversion system, in accordance with embodiments of the present disclosure. The protection circuit of FIG. 6 is substantially identical to the protection circuits of FIG. 3, FIG. 4, and FIG. 5. Accordingly, only those features that are unique to FIG. 6 are disclosed herein. For example, a MOV-TSPD circuit 600 can comprise a first TSPD D₁,a second TSPD D₂, a third TSPD D₃and a fourth TSPD D₄that are coupled in parallel to one another and connected to a first leg of switches Q₁ and Q₂(e.g., Q-1, FETS, GaN FET, etc.), a second leg of switches Q₃ and Q ₄(e.g., Q-2, FETS, GaN FET, etc.), a third leg of switches Q₆ and Q₅ (e.g., Q-3, FETS, GaN FET, etc.), and a fourth leg of switches Q₈ and Q₉ (e.g., Q-4, FETS, GaN FET, etc.), which are coupled in parallel to one another. The first TSPD D₁,the second TSPD D₂, the third TSPD D₃, and the fourth TSPD D₄ can be rated as described above. A first MOV G₁,a second MOV G₂, a third MOV G₃, and a fourth MOV G₄are respectively connected in series with the first TSPD D₁,the second TSPD D₂, and the third TSPD D₃, and a resistor R₁,a resistor R₂ a resistor R₃,and a resistor R₄ can be respectively connected between the first MOV G₁,the second MOV G₂, the third MOV G3, the fourth MOV G₄,and the first TSPD D₁,the second TSPD D₂, the third TSPD D₃, and the fourth TSPD D₄. The resistor R₁, the resistor R₂,the resistor R₃and the resistor R₄ can function similarly to the resistor R₁ the resistor R₂and the resistor R₃ of FIG. 4 and FIG. 5.

While the foregoing is directed to embodiments of the present disclosure, other and further embodiments of the disclosure may be devised without departing from the basic scope thereof, and the scope thereof is defined by the claims that follow.

1. A protection circuit configured for use with a power converter, comprising:
a Metal Oxide Varistor - Thyristor Surge Protection Device (MOV-TSPD) circuit comprising a first MOV and a second MOV connected in series with one another and a T-connection with a TSPD connected between a first leg of switches and a second leg of switches, wherein the MOV-TSPD circuit is configured to clamp the first leg of switches and the second leg of switches to a predetermined voltage during operation.

2. The protection circuit of claim 1, wherein the MOV-TSPD circuit is configured to be active only when the first leg of switches and the second leg of switches are switching.

3. The protection circuit of claim 1, wherein, under control of at least one of a controller or a grid interface of the power converter, the protection circuit is configured to shut down the power converter when an abnormal AC waveform appears, and
wherein the protection circuit is further configured to return the power converter to normal operation when the abnormal AC waveform disappears.

4. The protection circuit of claim 1, wherein the predetermined voltage is set by a combination of values for the TSPD, first MOV and the second MO, and resistors.

5. The protection circuit of claim 1, further comprising a second TSPD connected in parallel to the TSPD.

6. The protection circuit of claim 5, further comprising at least one resistor connected between the TSPD and the second TSPD.

7. The protection circuit of claim 1, wherein the power converter is one of a two-leg power converter, three-leg power converter, or a four-leg power converter.

8. The protection circuit of claim 1, wherein the first MOV and the second MOV are configured to trigger when a voltage at each of the first MOV and the second MOV equals exceeds a combined rated voltage for the first MOV and the second MOV.

9. The protection circuit of claim 8, wherein the combined rated voltage for the first MOV and the second MOV is about 420 V.

10. The protection circuit of claim 1, wherein the TSPD is configured to clamp voltage at the voltage rating of the TSPD.

11. A power conversion system, comprising:
a power converter;
a DC component coupled to a DC side of the power converter;
a plurality of switches coupled to a primary winding of a transformer; and
a bridge coupled to a secondary winding of the transformer and comprising a protection circuit comprising:
a metal oxide varistor-semiconductor protection thyristor (MOV-TSPD) circuit comprising a first MOV and a second MOV connected in series with one another and a T-connection with a TSPD connected between a first leg of switches and a second leg of switches, wherein the MOV-TSPD circuit is configured to clamp the first leg of switches and the second leg of switches to a predetermined voltage during operation.

12. The power conversion system of claim 11, wherein the MOV-TSPD circuit is configured to be active only when the first leg of switches and the second leg of switches are switching.

13. The power conversion system of claim 11, wherein, under control of at least one of a controller or a grid interface of the power converter, the protection circuit is configured to shut down the power converter when an abnormal waveform appears, and
wherein the protection circuit is further configured to return the power converter to normal operation when the abnormal waveform disappears.

14. The power conversion system of claim 11, wherein the predetermined voltage is set by a combination of values for the TSPD, first MOV and the second MO, and resistors.

15. The power conversion system of claim 11, further comprising a second TSPD connected in parallel to the TSPD.

16. The power conversion system of claim 15, further comprising at least one resistor connected between the TSPD and the second TSPD.

17. The power conversion system of claim 11, wherein the power converter is one of a two-leg power converter, three-leg power converter, or a four-leg power converter.

18. The power conversion system of claim 11, wherein the first MOV and the second MOV are configured to trigger when a voltage at each of the first MOV and the second MOV exceeds a combined rated voltage for the first MOV and the second MOV.

19. The power conversion system of claim 18, wherein the combined rated voltage for the first MOV and the second MOV is about 420 V.

20. The power conversion system of claim 11, wherein the TSPD is configured to clamp voltage at the voltage rating of the TSPD.
